(19) United States
(12) Patent Application Publication
(10) Pub. No.: US 2007/0061893 A1
(43) Pub. Date: Mar. 15, 2007

(54) Methods and devices for copy protection of software

(76) Inventors: Jeffery D. Black, Menlo Park, CA (US); Michael Ryan Fulton Ginn, San Francisco, CA (US)

Correspondence Address: FISH & RICHARDSON, PC, P.O. BOX 1022, MINNEAPOLIS, MN, 55440-1022, US

(21) Appl. No.: 11/518,541

(22) Filed: Sep. 8, 2006

Related U.S. Application Data
(60) Provisional application No. 60/715,734, filed on Sep. 9, 2005.
(60) Provisional application No. 60/715,516, filed on Sep. 9, 2005.
(60) Provisional application No. 60/715,628, filed on Sep. 9, 2005.

(51) Int. Cl. H04L 9/32; G06F 17/30; G06F 7/04; G06K 9/00; H03M 1/68; H04K 1/00; H04L 9/00; H04N 7/16

(52) U.S. Cl. 726/27; 713/181

(57) ABSTRACT

Disclosed are methods and devices for storing and accessing software on several devices such that any given purchased or licensed software title can only be run on one device at a time.

### REFERENCE TO PRIORITY DOCUMENTS

This application claims priority of the following U.S. Provisional Patent Applications: (1) Ser. No. 60/715,734, filed Sep. 9, 2005; Ser. No. 60/715,516, filed Sep. 9, 2005; and (3) Ser. No. 60/715,628, filed Sep. 9, 2005. Priority of the aforementioned filing dates is hereby claimed, and the disclosures of the aforementioned patent application are hereby incorporated by reference.

### BACKGROUND

This disclosure relates to systems and methods for coupling software to multiple devices while preventing the simultaneous use of a single purchased piece of software.

Many forms of copy protections exist, for games and other software. A customer may purchase a game for his or her personal use, but often discovers that they must either carry around a CDROM or some other form of restriction that prevents usage on multiple computers. As a result, if a user has 10 games, they may have to carry 10 forms of copy protection in the form of a CDROM or some other device in order to have access to all 10 games. Further, some game suppliers limit the number of computers upon which a game can be played to a single computer.

In traditional usage, software providers have had to generally choose between principally three alternatives of software copy protection:

1. Single Machine: A piece of software or a combination of software and hardware limit use to one machine.

2. Multiple Machine with Device: The executable is copy protected so that the executable only works when a protection device is present. Those experienced in the art will recognize that special CDROM's, dongles, USB Drives, and the like prevent operation in the absence of the protection device. Prior art also includes using the Internet to recognize two separate simultaneous uses of a single purchased piece of software by, for example, sending a code to a server when the executable portion of a piece of software is started and completed.

3. No Copy Protection: The executable is not copy protected, in which case the executable may be copied between users.

The choices represent tradeoffs between ease of use and sales lost due to illegal copying of the software.

For example, under scenario (1), a game of Tetris may only be registered on a single machine. If the customer purchases a replacement machine, the game may not transfer to the replacement machine, depriving the customer of the use of their purchased software.

For example, scenario (2) allows installing the software on multiple machines but requires that the customer carry around a device or connect to the Internet while they use the software. If the user damages or loses this device, or can not access the Internet (e.g. the user is on an airplane), then the user may be deprived of use of their purchased software. If the user has many such pieces of software, the user must carry around many devices or have access to the Internet.

Scenario (3) simplifies the user's experience, but risks radically reducing sales as users share the software, perhaps in a public space such as the Internet.

### SUMMARY

In view of the foregoing, there is a need for methods and systems which allow software to be used on multiple computers, while respecting the rights of the software maker such the software can only be used on one machine at a time. Games are but one example of software which has such limitations; other executables, documents, songs, videos, and other elements which are described under the definition of software can suffer from similar restrictions.

The system herein disclosed allows a given piece of software to be used on a single machine at a time. In one aspect, there is provided a mechanism that improves the customer's experience without sacrificing sales to illegal software copying. One realization is that multiple software developers could use a single, standard method for protecting software. For example, instead of requiring 10 CD's to activate 10 games, a single CD subscribing to the standard could be used.

Another realization is that users could choose between Internet validation and dongle validation. For example, Internet validation works best when the desired machines which participate in the system connect to the Internet so that only one computer can run a given piece of software at a time. As another example, a customer may use the system to obtain software from a variety of sources such that the software is unusable unless a unique dongle such as a USB device or a herein disclosed copy protected disk or any copy protected disk, or any other form of dongle which is herein disclosed, existing as a single unit and connectable to all computers as herein disclosed, is inserted in a given computer. As an example of this, within the system and following the methods herein disclosed, one may have 10 games executable on 10 computers, yet only one computer with the unique dongle will permit execution.

Another realization is that many pieces of software do not use the entirety of the software medium on which they are recorded. For example, a game may be only 50 megabytes in size, but require insertion of a CDROM for execution. Instead of carrying around a CDROM for each pieces of software, a customer could carry a single device or use the Internet. Virtual CD and Virtual Drive, trademarks held by respective parties, are examples of software which copy the contents of a CD onto a computer's hard drive, creating images of up to 650 megabytes. If the critical elements of a game are known, then one could store, for example, 10 times more software on a personal computer's hard disk. This is because only the critical files would need to be stored.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 depicts an exemplary embodiment of a system according to the invention.

FIG. 2 depicts an exemplary embodiment of a CD 200 which may or may not use protection.

FIG. 3 depicts an exemplary embodiment of an external device (hereinafter “dongle”) protection.

FIG. 4 depicts an exemplary embodiment for external device (hereinafter “dongle”) protection based upon utilization of the herein disclosed CDROM functionality.

FIG. 5 depicts an exemplary embodiment of a method for dongle-based protection.

FIG. 6 depicts an exemplary embodiment of a system for Internet-based protection.

FIG. 7 depicts an exemplary embodiment of a method for Internet protection.

FIG. 8a depicts an exemplary embodiment of payment process

FIG. 8b depicts an exemplary method of running trial software

FIG. 8c depicts an exemplary method of running crippled software

FIG. 8d depicts an exemplary method of distributing free programs according to a policy.

FIG. 9 depicts an exemplary method for increasing the compression associated with a piece of software.

FIG. 10 depicts an exemplary way of organizing an alternative programming language to obfuscate copy protection

FIG. 11 depicts an exemplary way of checking to ensure all expected checks are accounted for.

FIG. 12 is an example of the at least one embodiment in use.

FIG. 13a is yet another example of an embodiment in use.

FIG. 13b shows another embodiment.

FIG. 14 is an example of data and programs which can be arbitrarily spread between the dongle and computers' memories

FIG. 15 is a sequence of operations for extracting a passcode given the serial number of a dongle for unique certificates, encryption, decryption, RSA encryption, or the like.

FIG. 16 is a depiction of one possible difference between prior art and the system herein disclosed.

### DETAILED DESCRIPTION

Some variations of the disclosed systems and methods are described below. Other variations will occur to those skilled in the art; they are implicitly included in this disclosure.

The following definitions are provided to define various terms used:

Software: can be executable code, computer games, a list of songs, videos, maps, documents, or the like, with or without copy protection or digital rights man agement. In one embodiment, the software can not be used without a single specially designed CDROM herein disclosed.

Runner: a runner is a piece of hardware which can include, for example, a CPU, memory, a mechanism for powering the device, and at least one input/output device. Runners are used to execute software and to provide access to software (such as movies, images, music, documents, or the like). In one embodiment, only one runner of all the runners containing a given piece of software (essentially backups of the software) can execute or allow access to that piece of software. Note that some software may not be protected on a runner, such as an MP3 song which has been released into the public domain.

Dongle: a dongle is a piece of hardware which connects to a runner and controls access to that runner, such as to indicate that the runner may allow access to the protected software on that runner. For example, a dongle can be a memory stick, a specially protected CD using mechanisms elsewhere disclosed, a simple electronic circuit with or without flip flops, AND gates, NAND gates, inverters, NOR gates, OR gates, or a ROM device, or any other hardware device which a program can use to determine that the circuit is a unique piece of hardware suitable for preventing a piece of software existing on separate machines from being used simultaneously.

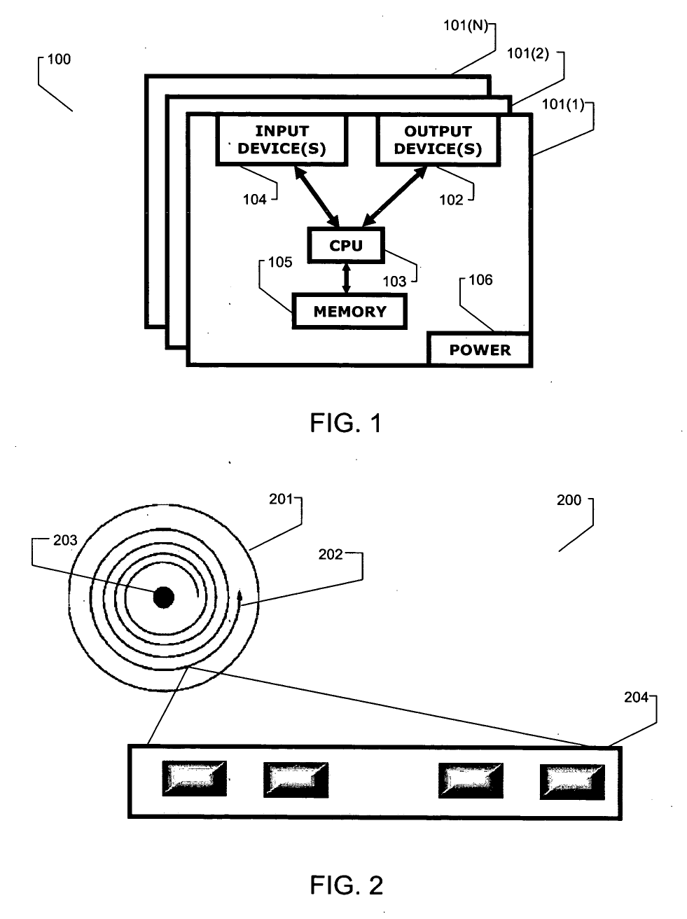

FIG. 1 depicts an exemplary embodiment of the system 100. In this embodiment, any number of computing devices (hereinafter “runners”) 101(1), 101(2), . . . 101(N) receive and store a copy of the protected software 150(1), 150(2), . . . 150(N). The computing devices are typically comprised in part of one or more CPU's 103 (examples include Intel Pentiums, 6502-based microcontrollers, and the like), memory 105 (examples include 2 gigabytes of RAM, 100 gigabytes of hard drive space, or 100 terabytes of holographically stored memory cubes), one or more output devices 102 (examples include LCD displays or speakers), one or more input devices (examples include touch-sensitive screens, microphones, keyboards, a mouse, or the buttons on a watch), a port 102 combined with 104 (for example a serial, parallel, or USB port), and a source of power 106 (for example drawing power from a USB connection, otherwise drawing power from the inputs or outputs, using a small battery, using an oscillating magnetic field, or using AC power which has been converted to an appropriate voltage, all according to the state of the art).

Optional input/output devices include a USB port 107 and/or a network communication device for example an Ethernet input/output subsystem 104, as another example a wireless input/output system which uses a wireless protocol to send information, as another example a proprietary or public network communication standard. Other input/output devices will occur to one skilled in the art.

Variations of runners include watches, music players, PDA's, cameras, video cameras, computers inside cars, computers inside airplanes, computers used as prosthetic devices, biometric recognition devices, and the like.

In some embodiments of the invention, the software is stored in the runner's memory. Alternatives include using communication channels which receive some or all of the software by electronic or electromagnetic means, for example by radio reception, by modulation of the power lines in a house, by flashes of light, or by ultrasonic transmission.

FIG. 2 depicts an exemplary embodiment of a CD 200 which may or may not use copy protection. A CD consists of a hole in the center to facilitate rotation 203, an outer edge which could be different shapes 201 (such circular or business card shaped). The data is typically stored in a spiral pattern 202 of 1's and 0's based on reflective properties of the presence or absence of an indentation or other means of reducing the direct reflection of light 204. Copy protection can take many forms. Some exemplary forms are described below.
It can write to special areas of the disk. It can use Zone 3, for example, as a storage area for a signature random ID which is checked before the program is executed.
It can intentionally indicate sectors are bad when in fact they are not. The system then looks for the bad sectors before executing, examining their contents for a signature which is written to the bad sectors.
It can intentionally include more information than is indicated by the ISO CD file system. Such information is stored in an ostensibly unused area; the copy protection checks for that information.
To impede replication, the CDROM may have special characteristics. For example, the disk may or may not follow ISO standards; by following an alternative standard, a program can detect unique characteristics which mark the CDROM as tied to the purchased software and therefore enabling the use of software.
The CDROM disk may or may not have error correction codes (ECC's) which provide redundancy so that if some portion of the CDROM is mis-read, mathematical algorithms can be used to reconstruct the data. Even if the CDROM has ECC's, it may “purposefully” have errors which are used to distinguish a copied CDROM with corrected errors from the original CDROM.
The CDROM may use certain portions of the disk (such as a particular “ZONE” such as “Zone 3”) to store information which is typically not read; by reading from these portions, a runner may be able to distinguish between a copied CDROM and the original.
The CDROM may be encrypted using a key which is stored in a location which is difficult to find by one who is outside of the corporation publishing the CDROM, hiding it in areas which are not normally used by an ISO standard, such as between tracks. The key may also be typed in by the user.
Those skilled in the art of protecting software using CDROM's have a wide variety of additional techniques for impeding carrying identifiable characteristics of a given CDROM over to a copy of that CDROM or over to a “virtual copy” (for example, a copy stored on a runner's hard drive).

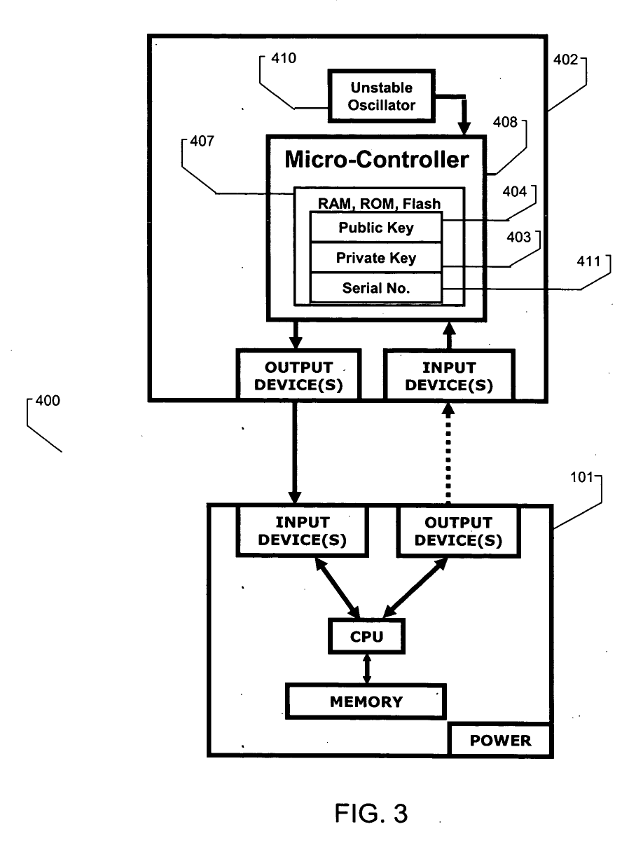

FIG. 3 depicts an exemplary embodiment of a system 400 for external device protection. A system 400 including an external device for protection and validation 402 (hereinafter a “dongle”) is a device well known to those skilled in the art. It is a piece of hardware which can be connected by a given means to a runner so that the runner is able to distinguish the dongle (associated with purchased or licensed software) from an emulation or copy of the dongle.

In the form depicted in the diagram, a challenge-response system is used to validate that the runner 101 is connected to a valid dongle 402. The dongle uses a microcontroller 408 which includes memory 407 (for example, static, flash, ROM, or other memory that does not require power). The dongle uses its own private 403 and public 404 keys of the runner and in this embodiment is fed a public key from the runner 101. The private key 403 is stored in such a fashion that it is extremely difficult to extract from the Micro-Controller 408 once it has been stored. A serial number may or may not be additionally stored in the dongle 402. 410 is an unstable oscillator for quickly generating random numbers which are needed for validation.

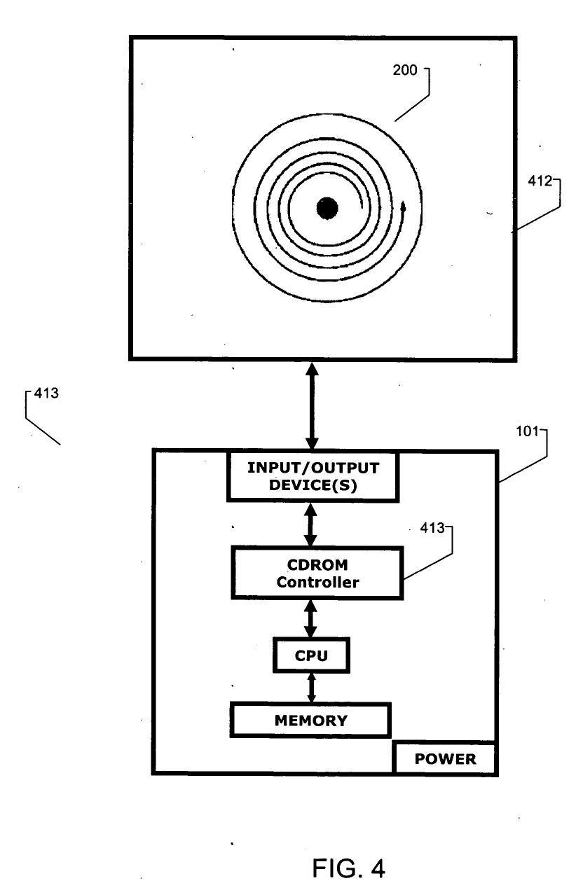

FIG. 4 depicts an exemplary alternative embodiment 413 of the dongle combined with the runner. The runner 101 includes a CDROM controller as one of its input/output devices, connected to a CDROM reader 412 and a CDROM 200. If the CDROM 200 is valid, then all of the software in the runner can be executed.

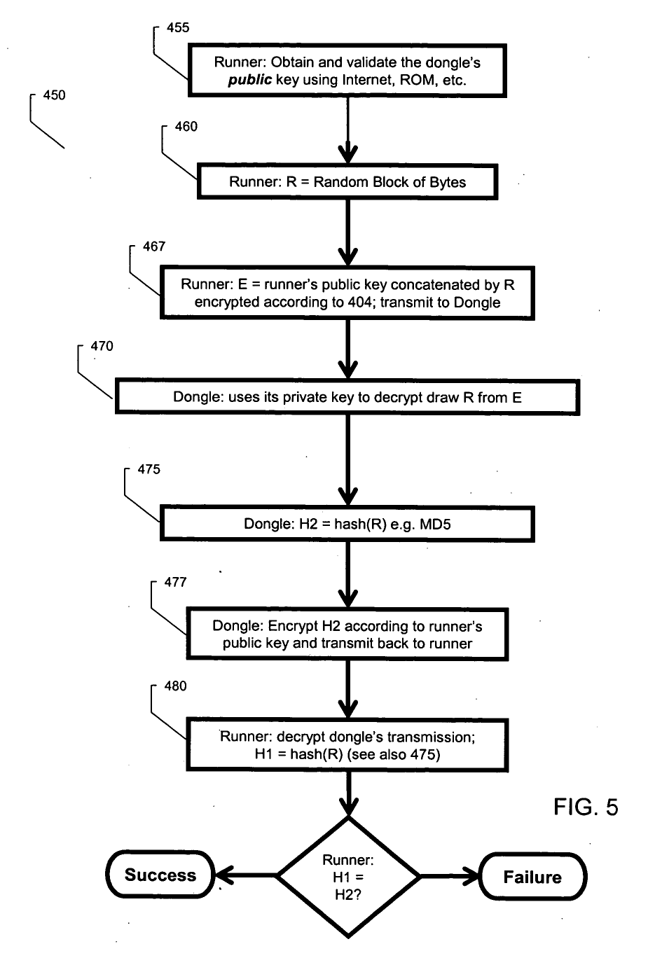

FIG. 5 depicts but one method for validating dongles 450. First, at 455 the public key 404 of the dongle is obtained and validated. In one embodiment, the runner queries using the Internet using an SSL connection to a server to validate the association of the serial number 411 and the public key 406. Alternatively, the runner 401 contains a list in ROM of all valid serial numbers 411 and public keys 404. Alternatively an algorithm can be applied to the dongle's public key to determine its validity; because of the nature of the public key, the algorithms may be limited. Others skilled in the art will be aware of other variations for validating the public key of the dongle 406.

Then at 460 a random block of data R is generated by the runner using a method known by those skilled in the art. For example, it may use an unstable oscillator 410, a high-frequency unstable oscillator involving a diode which is not susceptible to resonating with nearby radio stations or other sources of radio frequencies, can be used, by careful time-delayed sampling, via a Schmidt trigger, to successively generate 0's and 1's.

Then R along with the runner's public key 404 are encrypted into a block of bits E according to the dongle's public key 406 using mechanisms well known to those skilled in the art of public key encryption. The result is transmitted 467 to the dongle. Then at 470 the dongle uses its private key 403 to decrypt E. Then at 475 the dongle assigns H2 to be the result of applying a hash function, such as MD5 (or a stronger hash code algorithm is used), to R. It then at 477 uses the runner's public key to encrypt H2 and transmit the value of H back to the runner.

Then at 480 the runner independently computes H1 (the result of applying the same hash code algorithm used by the dongle to R). It compares the value of H1 to the received value H2. If they are the same, the dongle is determined to be valid. Alternatively, the dongle is determined to be invalid.

If the dongle is valid, the system runs all protected programs stored on the runner. Alternatively, each protected program performs an independent validation of the dongle.

Alternatively, the value H1 is used to create a dispersion of valid values to be used throughout the program, said values stored in the microcontroller, near the top of the stack, in the data store, or the like. As the program is executed, at random points in time, values of H2 are used. By the nature of the program, a difference in the two values will cause a detectable error; for example, one check may be an equality check between one bit in H1 and the corresponding bit in H2. In the case of such an error, the program ceases to function, and a message according to the developer's choice is displayed.

Other variations will occur to those skilled in the art of encryption. In but one example, the dongle could consist of a ROM which plugs into a parallel port with flip-flops connected either in tandem or independently, triggered by incoming address lines and reset by a final address line. The result provided to the runner is a value of a specific address which is partly derived from the address lines and partly as a function of the previous addresses queried. By checking these against a table, the runner could validate the dongle and run or play purchased or licensed software. The dongle could be placed in a package (for example embedding the dongle's components in a brittle, opaque plastic or embedding the dongle as a single chip in a brittle material) so that attempts to investigate the composition of the dongle would be foiled by a complete destruction of the components.

Other variations in dongle validation and the electronics of a dongle will occur to those skilled in the art.

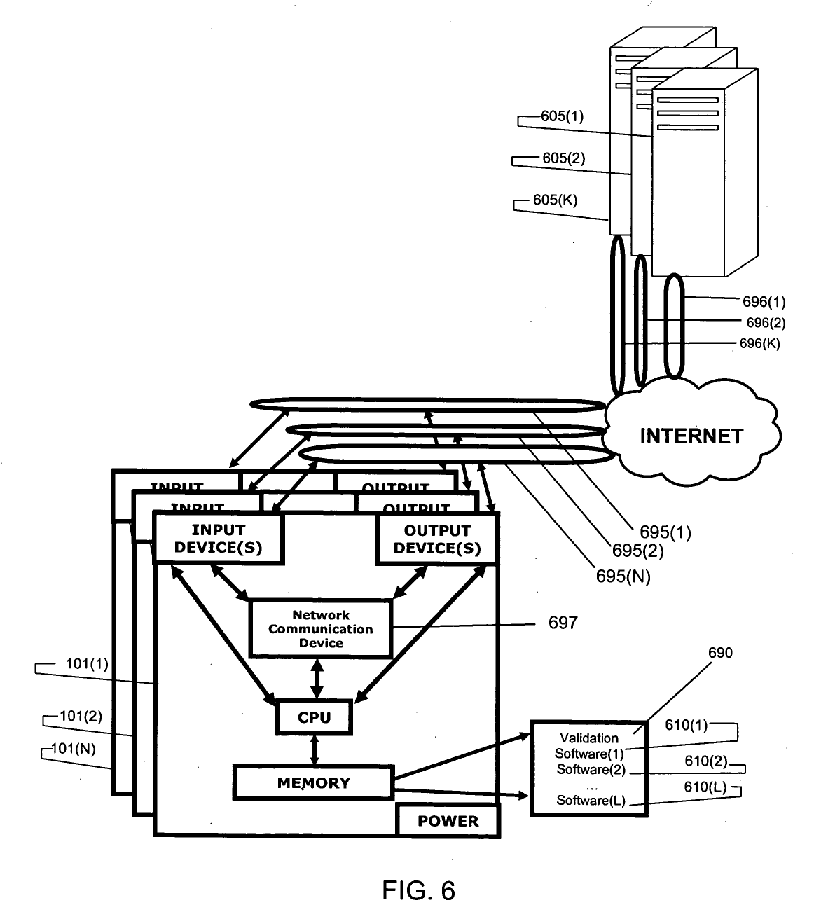

FIG. 6 shows one embodiment of a system for Internet-based protection. N runners 101 each contain a validation mechanism 690. The N runners 101 also contain L software titles 610 which have been obtained as described. The N runners 101 communicate in one embodiment using one network communication device 697 and/or N network devices 695 (possibly, but not limited to, translation to wireless TCP/IP connections, Ethernet connections, or any other connection to one or more servers). In the case that there is no network communication device 697, the network devices 695 would typically do some conversion to allow the connection. In the case that there is a network communication device inside the runners 101, then the connection could be wireless, infrared, Ethernet, or the like, the network devices 695 could consist merely of cables, an alternative connection to an internet-connected PC, an antenna, or the like.

In an alternative embodiment, the N runners 101 incorporate a USB input/output device 698 (or alternative communication mechanism appropriate to the dongle medium) for the purpose of connecting a dongle. The N runners connect to K servers 605 via K network components 695, typically comprised of a cable.

Memory on the runners contains a program 690 which implements the methods herein disclosed as well as handling the additional functionality unique to each runner (for example, if the runner is a camera, the additional functionality would software which facilitates taking pictures). The memory contain hashes and ID's corresponding to the software, as later herein disclosed,

Other embodiments will occur to one skilled in the art. For example, instead of using the Internet, one may use a private network which uses an alternative to TCP/IP.

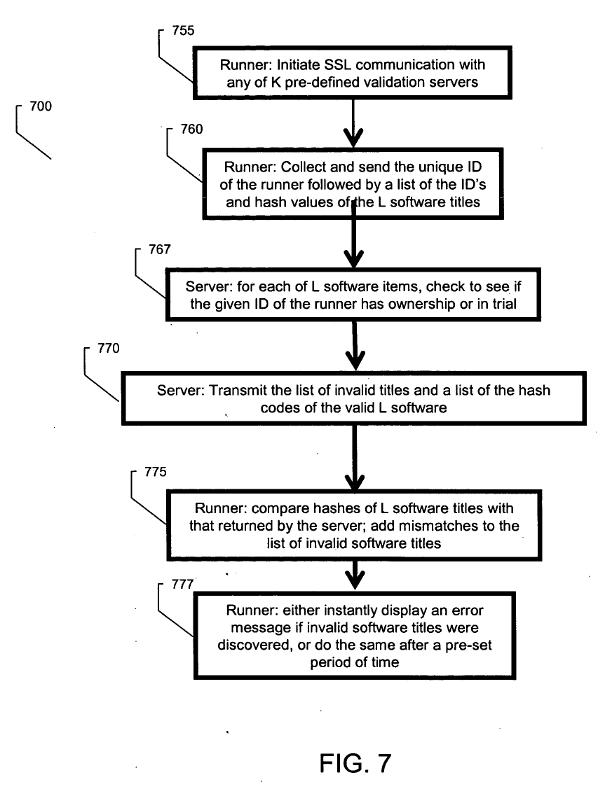

FIG. 7 shows one embodiment of method for Internet protection.

One possible embodiment for validating the N software 150 unit(s) follows. Each runner has a unique ID which is encrypted or stored in some other fashion which is not easily detected by someone attempting to foil the system.

First, at 755 SSL communication is initiated with pre-defined valid servers. Using SSL, one can validate the servers using public key validation as known to those skilled in the art of using public key certificates. The host file is checked for re-direction, and similar checks are used to ensure only valid servers get the SSL connection.

Then at 760 the hash (for example MD5) of the body of each of L software titles is inserted into a buffer. Then, program ID's 610 on N runners 101 and on K servers 605, along with the unique ID for the runner, are placed in the same buffer.

The servers at 767 look up the validation information, using or not using hash information but definitely using the software title ID's, the runner's ID and transmit at 770 their results back to the runner.

The runner takes the ID's of the given piece of software or a subset of the software (for example a program which plays music and a piece of music) and places it in a list. The list is sent to the server(s). For each program ID the servers return errors when the ID's are invalid as based on the purchase server database, or a trial has been exceeded. If the title is valid, the hashes are compared (at 775) and if different, an error for that title is flagged at 777. If the server does not perform the hash comparison, then it is performed on the runner.

Depending upon the policy of the organization implementing the system, a failed title leads to a deletion of all software titles. Otherwise, the specific invalid titles are marked as non-executable and an error is provided to the user right away or after a delay so that the user does not associate using the Internet with the software title checking facility.

In another embodiment, a process similar to those described above is used, with an identifying packet sent upon a given time interval. When a piece of software terminates, it sends a termination packet to the server(s). If the server(s) receive validation from more than two devices simultaneously, then an error is returned, indicating that more than one piece of software is being used at a time.

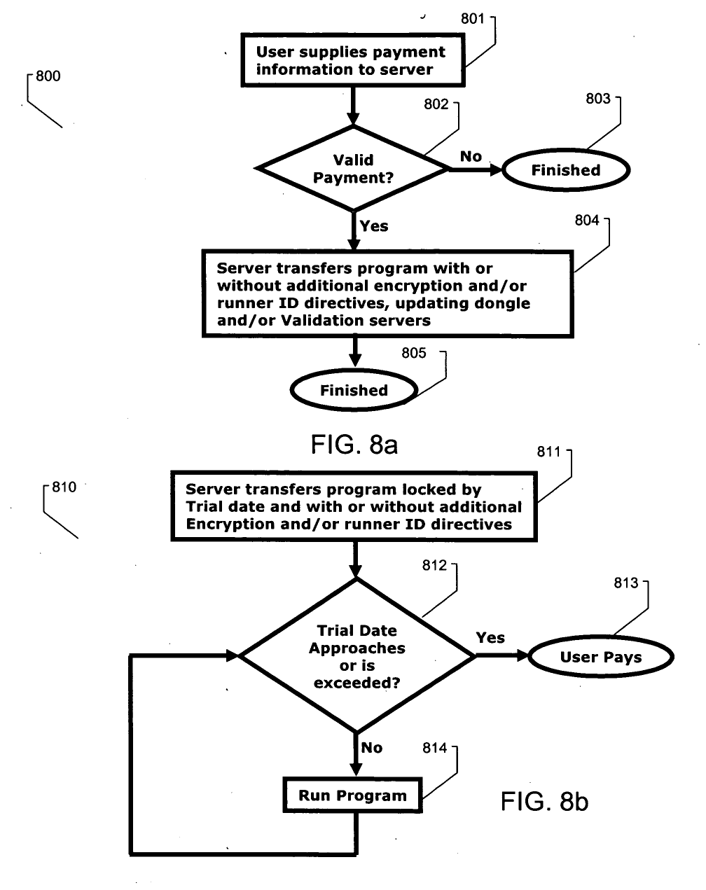

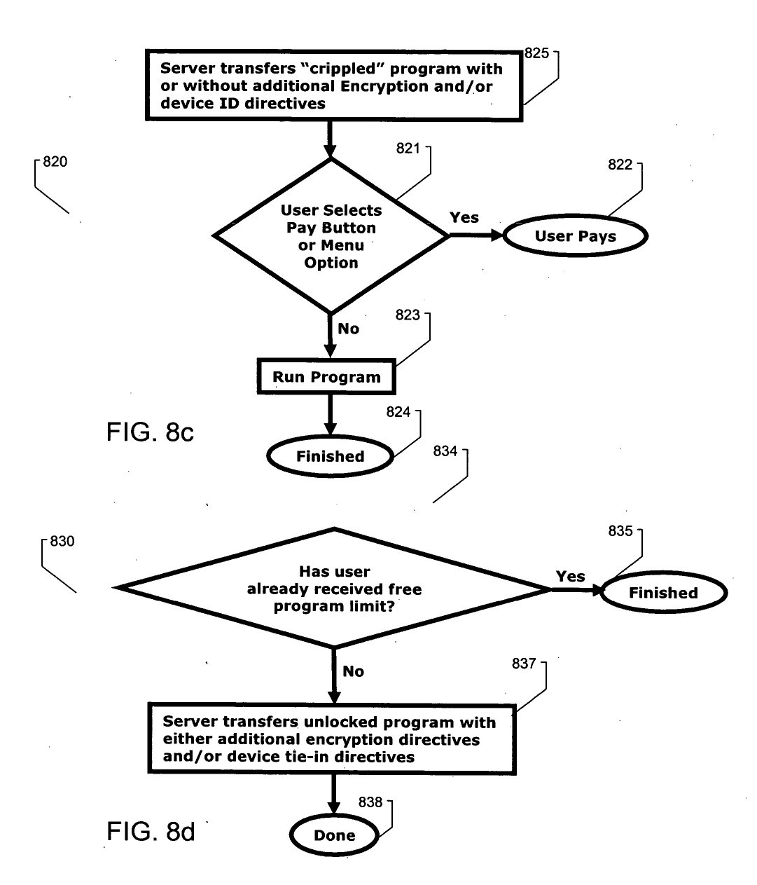

FIG. 8a depicts an exemplary embodiment of payment process. Payment and insertion of the corresponding software into the Internet or the dongle is described in method 800. First at 801, the user supplies payment information to the server. If at 802 the payment is valid, then at 804 server transfers program with or without additional encryption and/or device ID directives, updating dongle and/or validation servers transfers the program with or without additional encryption and/or device ID's. The program finishes with failure at 803 or success at 805.

FIG. 8b depicts an exemplary method of running trial software. In method 810, the server transfers at 811 the program locked by the trial date and with or without additional encryption and/or runner ID directives. If the trial date at 811 approaches or has passed, then at 813 the user is required to pay for the program to use it. A process similar to FIG. 8a is followed.

FIG. 8c depicts an exemplary method of running crippled software. In method 820, the server transfers at 825 a “crippled” program, that is, a program which does not have the full functionality of the retail version, with or without checks, and installs the program into the dongle and/or the validation servers.

If at 821 the user selects pay button or menu option, then at 822 the user pays for the retail version, and a method similar to that depicted in FIG. 8a is followed. If not, at 823 the program is run in its crippled form. At 824, the method completes.

FIG. 8d depicts an exemplary method of distributing free programs according to a policy. In method 830, at 834 the system first checks to see if the user has already met or exceeded the limited. If so, at 835, the program is considered finished. Otherwise at 837, the distributing server transfers the unlocked program with either additional encryption directives and/or device tie-in directives such as with a dongle or a media.

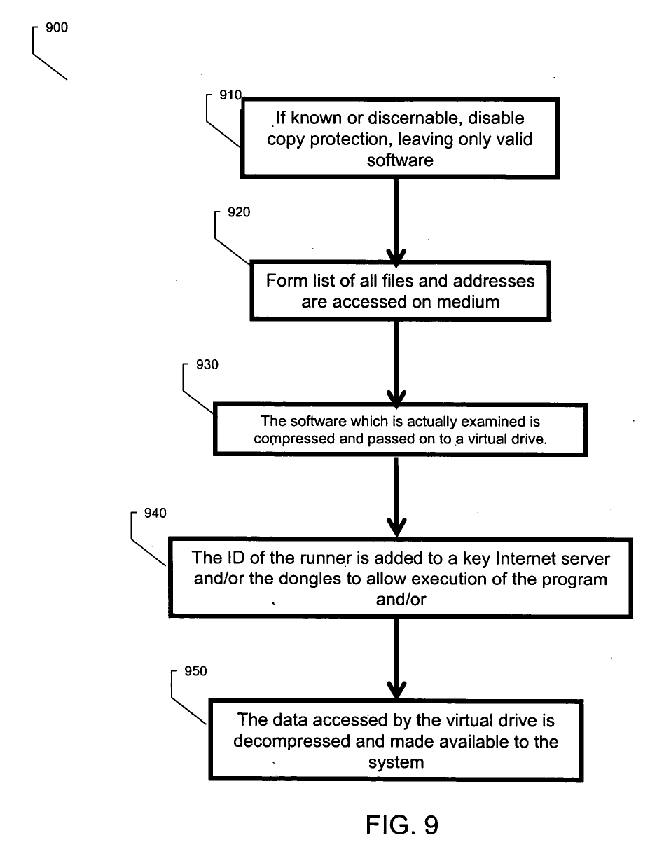

FIG. 9 depicts an exemplary method 900 for increasing the compression associated with a piece of software. First, at 910 in some embodiments, the runner executes a copy protection disabling mechanism known to those skilled in the art, potentially based upon knowledge about the protection invention or knowledge about the hardware.

Second, at 920 the given software to be protected is run in such a manner that the list of accessed of files potentially including absolute checks of memory locations in the medium from which the program is taken. In some embodiments, the software is run completely by either a human or by an automated simulator to ensure that all of the software that is needed is exposed.

Third, at 930 the software which is actually examined is compressed and passed on to a virtual driver known by those skilled in the art (for example, the virtual drive program CD Drive). As the data is accessed from this driver, it is uncompressed for used by the invention.

In most cases, merely copying the input to the virtual drive will fail to allow use of the software because of the use of Internet-based validation and/or dongle-based validation. In one embodiment, at 940 the addition is performed by drawing upon the ID associated with the runner and adding the additional needed information. Instead, or in addition, the same is performed on the dongle.

In one variation of this invention, a corporate policy can allow simultaneous use of two or some other constant number of given software at a time. For example, this may be done by the manufacturer may only issue two to be used by each set of software package they sell. As another example, a software manufacturer may use Internet-based tracking to ensure that a given licensed program is used on only five machines at a time.

Note that it in but one embodiment it is possible to eliminate external hardware such as CD's or dongles by using similar principles to those herein disclosed within a set of runners. Namely, through the use of the Internet or a smartcard or by encrypting the information in the memory of the unit, the runner is provided with proof that ownership of software is in the user's hands.

Note that those skilled in the art such as the inventors of CD Drive and Virtual CD use technology to separate a given media's useful data from the media's code and data used to prevent copying. In such a variation, they make the useful data available to the user through the assignment of a drive letter and a virtual file invention, and often use the media's copy protection data to identify the mechanism used for copying.

In most embodiments of this invention, at 950 the system copy protects the software or has custom copy protection incorporated into it. First, software could be distributed by downloading from a pool of variations, each with different checks incorporated into it at different places, including just-in-time decoded forms of encrypted software which appear to be valid instructions (by, for example, having a large section of apparent code which includes within it the constants needed to convert to a smaller check and then executing the check); thus, the encoded checks execute. Second, the checks which are performed during a given time interval (such as a week) could be completely different. This way, a adversarial programmer who finds the checks for one week may not find the remaining checks.

Third, the checks could include the following:

Internet checks possibly including a program's serial number or other ID check which may additionally use a predictable by continually changing ID.

Checks which obtain validation from the dongle and possibly store the result of the validation in any given memory location, including placing valid values in memory locations which are needed by the program in the natural course of execution.

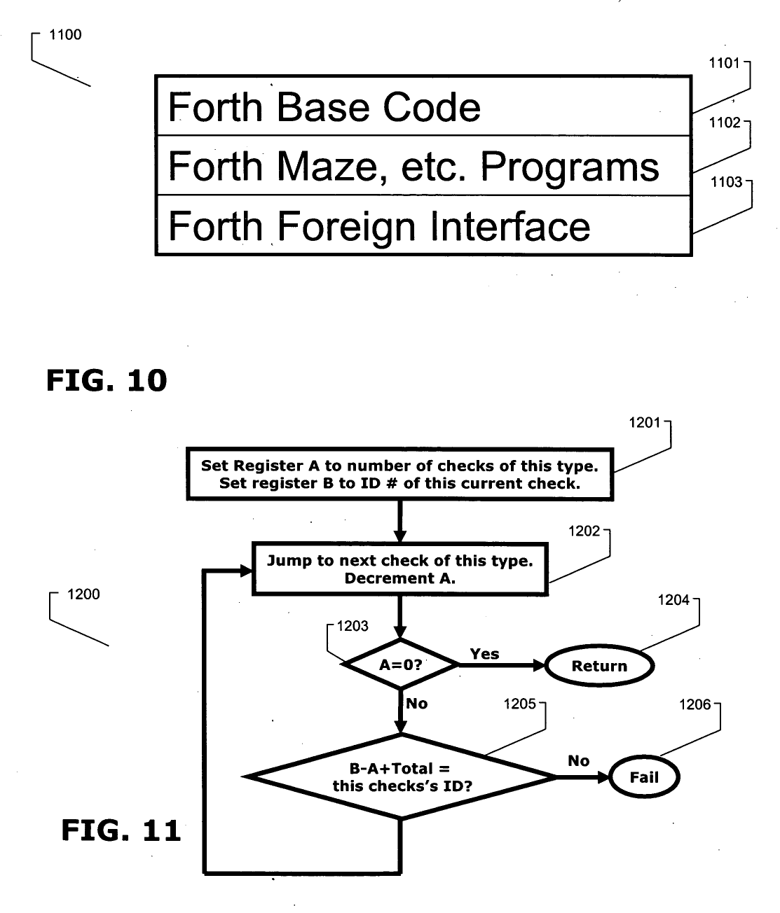

Checks which check the validations stored in a previous check at another time so that detection is isolated temporally from notifying the user with a custom message indicating the software can not be used.
Threads which execute in turn, passing a changing code back and forth with timeouts. The timeouts may indicate the presence of debuggers by adversarial programmers who seek to violate the system.
Checks for active debuggers on the machine.
Checks encoded in programs such as FORTH (FIG. 10 reference 1100) with their contents 1101 placed in numerous places in the program. Simple algorithms such as the computation of a fractal 1102 can be used to create complexity for those attempting to break the checks. The system has a foreign language interface to facilitate integration with various programs 1103. Machine-generated code can also be used to increase the complexity of tracking the checks. Such checks can be performed in such a way that successive checks or critical values in valid software execution or
With reference to FIG. 11: Checks which are numerously placed through the system, for example 10 times; calling one of the checks ensures that the remaining checks exist and are unmodified 1200. This is part of the strategy of creating multiple executables with slight variance from one another. First the data is initialized at 1201. Then the system jumps to the next check at 1202. If the total number of checks has been performed at 1203, the system returns at 1204. Otherwise at 1205, a check is made for the ID of the current check. If at 1205 they do not match, then at 1206 the check fails. Otherwise, the next check is examined at 1202.

Thus, as shown in FIG. 10, some embodiments includes a system 1100 that uses a programming language such as FORTH 1101 to create FORTH maze-like machine-generated code 1102 which confounds attempts to disassemble executable code. The foreign function interface 1103 allows arbitrary code from the rest of the executable software (as opposed to software which consists purely of media, such as music).

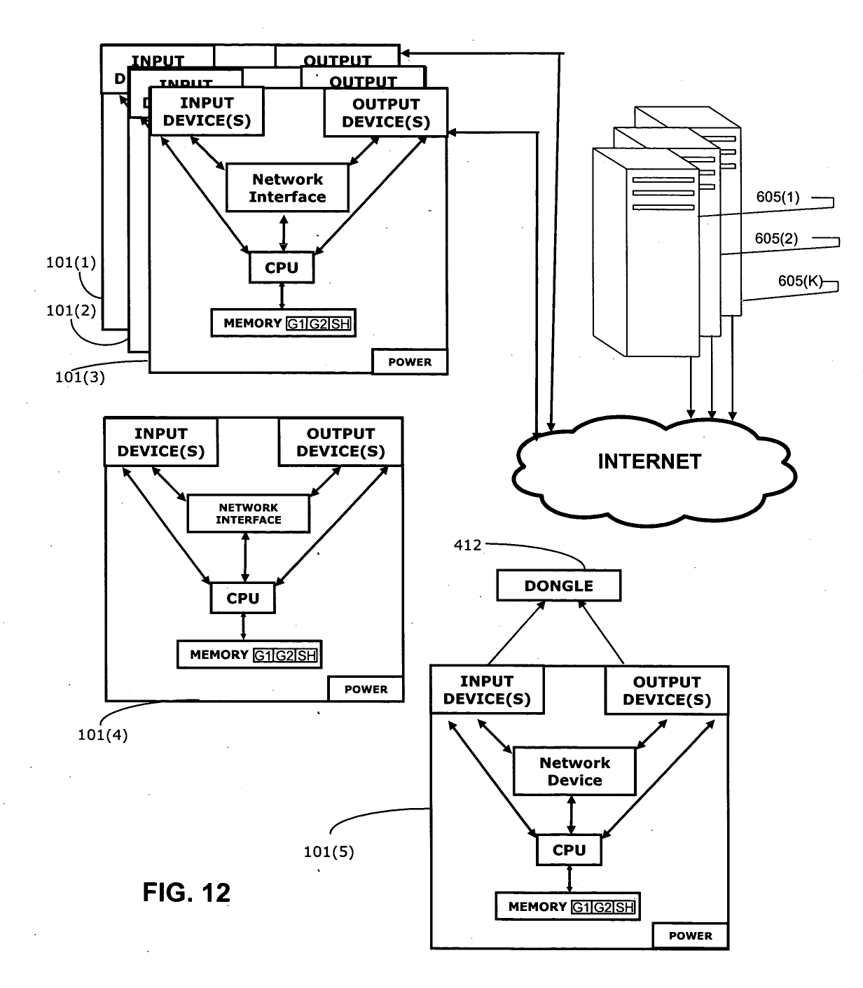

FIG. 12 shows a visual representation of an example of the high utility of at least one embodiment. Copy protection, for example that described earlier where a CDROM can be used as a dongle 402, may not only reduce legal problems, but also prevents a person from copying software beyond the software's licensing conditions. It is also done to create a win-win situation for developers (their software becomes more usable without sacrificing profits) as well as users (their software is available on multiple computers). This may improve protection, but it will give someone using a game not only the backups they need in case of media failure, but also the ability for a single individual to play the game on any machine, as depicted in FIG. 12.

The software is stored on CDROM, optionally unprotected, and stored on the runner 101; or it is downloaded as described previously; note that the runner account has a 1:1 correspondence to a given customer, tracking the purchase of trials and other downloads, as enforced in one embodiment by the validation program 690 as later herein described. In one embodiment, the main CDROM executable is wrapped in an executable using techniques known to those skilled in the art. This wrapping adds checks, encrypts the original executable, and/or checks to see if this user has downloaded the game onto a different machine.

Enforcement is performed by a variety of means known to those skilled in the art, including storing on the server 605 the ID from the processor on a runner 101, in the process generating a unique ID for each machine and associating it with the downloads and/or CDROM conversions performed by the software. The ID is stored in a number of places, for example within the executable of the shield, hidden in the registry, derived from machine characteristics such as the serial number of the CPU or the primary MAC address of the network of a machine, or any other technique known to those skilled in the art. Thus, enforcement is performed by ensuring the same program is not executed by two separate runners, using at least one of the following techniques:
Every runner is connected to the Internet. The K servers 605 check to ensure that sessions of software use do not overlap. In one embodiment, this is performed by getting a message when a piece of software is in use, and a second message when it is not via TCP/IP messages which include the ID of the runners. In such an embodiment, software “times out” automatically; that is, the program may close automatically after a selectable time of lack of use. This reduces the chances that the user may not have access to a runner, which is “already using” software at a different location.
A token is passed between the runners indicating which runner has “ownership” of the software at a particular point in time.
A certificate on each runner using PKI technology passes a token indicating which runner will allow the software (whether it be a game, music, video, or the like) to be executed. The token may start on runner (101)1, and then be transferred to runner 101(2) through a user interface; the token can be transferred by any cross-computer mechanism, including serial ports, USB ports, or the like.
A dongle is used so that no runner can execute a given piece of software on more than one runner without a dongle.
A user can transition to a different mechanism by the following means:
   If they were previously using the Internet to ensure single use, then K Internet servers 605 are used to determine which runner, if any, is currently using the software. The user is asked to terminate such use if the user wishes to change to one of the other methods on a different runner. From this point, any of the 3 methods can be used.
   If they were previously using certificate exchanges between runners, and if the software is in use, then the starting point for the runner, which is using the software is the runner which has the token. From this point, any of the 3 methods can be used.
   If they were previously using a dongle (or a protected CDROM) to indicate which runner was using the software, then the dongle is disabled and an alternative method is selected. Note that disabling the dongle can require network or certificate exchanges between all machines which could run the software, since otherwise more than one machine could use a piece of software at the same time; for example, a runner using an Internet policy and a runner using a policy based on a dongle.
   In one embodiment, it is possible to send a “kill” message to the runner which is currently “being used on” other runners; however, unless the software is no longer in use on that runner, the switch will not take place.

Those skilled in the art will derive other mechanisms for ensuring that only one piece of a given piece of software is run on separate runners at the same time, including combinations of the aforementioned techniques. Such variations are implicitly included in disclosed systems.

In FIG. 12, there is also demonstrated an example use of the machine. In all of 5 runners 101, game 1 and game 2 are stored, along with the shield SH (the software that helps customers purchase titles, downloads titles, wraps and copy protects executables so that they must follow a given policy, and the like). 101(1) may be a work computer, 101(2) may be a business laptop computer used for traveling, 101(3) may be a home computer, 101 (4) may be a laptop placed in the back seat of a limousine, and 101(5) may be a laptop with a long battery life for use on cross-continental flights. The dongle may be an ideal choice here; instead of carrying 10-100 game disks or software DRM protection scheme hardware, the customer can carry just the small dongle around with them.

Note that in some embodiments, the flash screen shows the name (which may be encrypted within the program to reduce the anonymity of illegal copying. The information is encrypted and stored in different places on different executions to make removing the name more difficult.

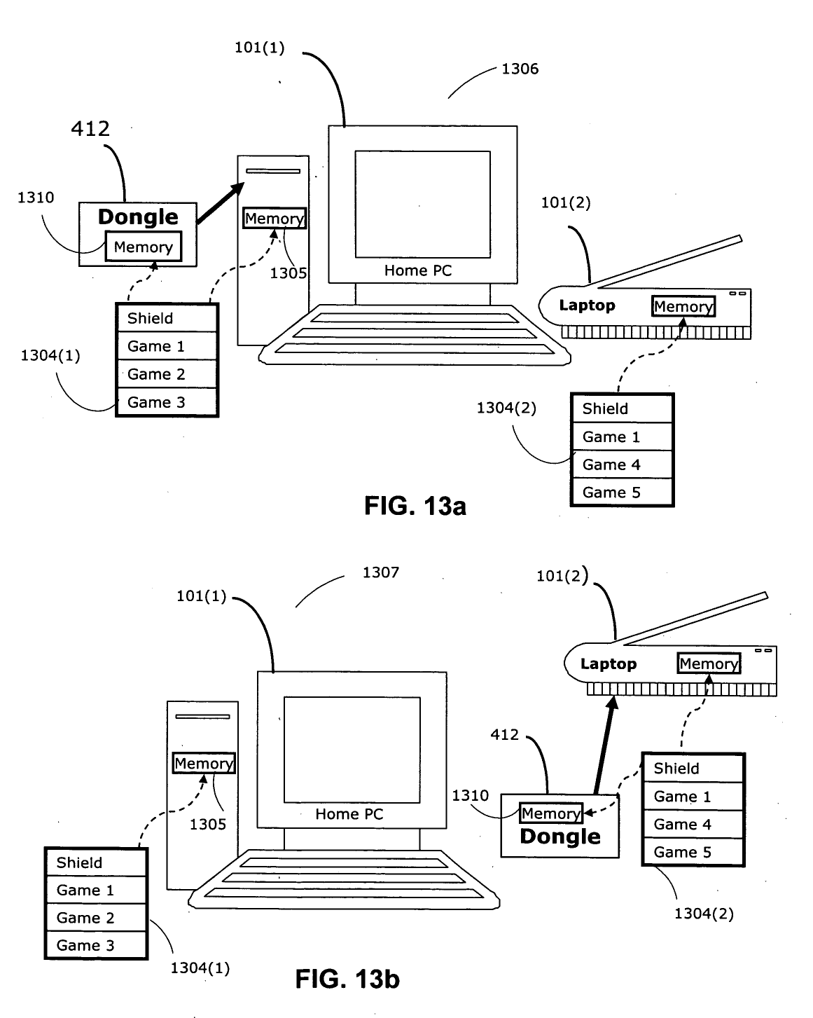

FIG. 13a depicts an embodiment 1306 wherein a computer user has two PC's, a laptop 101(2) and a desktop 101(1). Both have the game title Game1 (for example, the game DeluxeLines), as well as the protective program Shield which, as part of the system, controls the access to the games as a function of the presence of a valid dongle 412. In this case, the dongle is connected to the desktop PC. With the dongle connected to the desktop, the user can only use Game1, Game2, and Game3 on the desktop 101(1); attempts to use Game1, Game4, a/or Game5 on the laptop 101(2) will fail.

If the dongle 412 includes memory 1310 then it may or may not include a portion or files from each of the Games, or MD5 hashes of said programs, or other mechanisms for ensuring that the games have been inserted using the method disclosed herein. If the dongle does not include memory, then similar functions are carried out by the program on 101(1) and a challenge-response approach known to those skilled in the art will be used as the basis for permitting the execution of Game1, Game2, and Game3. Note that 412 can also be a difficult-to-copy medium with a serial number, such as a CD 200 which is already prepared for the customer using the method and system disclosed elsewhere in this document and often containing as data the programs comprising those used by the disclosed system. Detecting the proper unique dongle, the herein disclosed program stored primarily on the computer's 101(1) memory 1305 permits access to the files and/or executables stored on 101(1). In one embodiment this access is controlled through encryption and decryption.

FIG. 13b depicts one embodiment 1307 which differs from FIG. 13a only in that the dongle 412 is connected to the laptop 101(2) instead of the desktop 101(1). With the dongle connected to the laptop, the user can only use Game1, Game4, and Game5 only; attempts to use Game1 and/or Game2 and/or Game3 on the desktop 101(1) will fail.

As will be clear to one skilled in the art, in one embodiment, this system can permit any piece of software protected by the method and system herein disclosed to allow one piece of software to run on one machine while simultaneously allowing the use of different protected software on a different machine. This preserves the restriction that no single piece of software is used simultaneously on multiple machines, yet allows the user flexibility in using one piece of software on one machine 101 and another piece of software on another machine 101.

In one embodiment of the system, the full body of bytes 1304, comprising the protected files along with the executable shield program which protects the bytes, is stored completely on the system 101(1). Alternatively, arbitrary subsets may be stored on the dongle or on the PC.

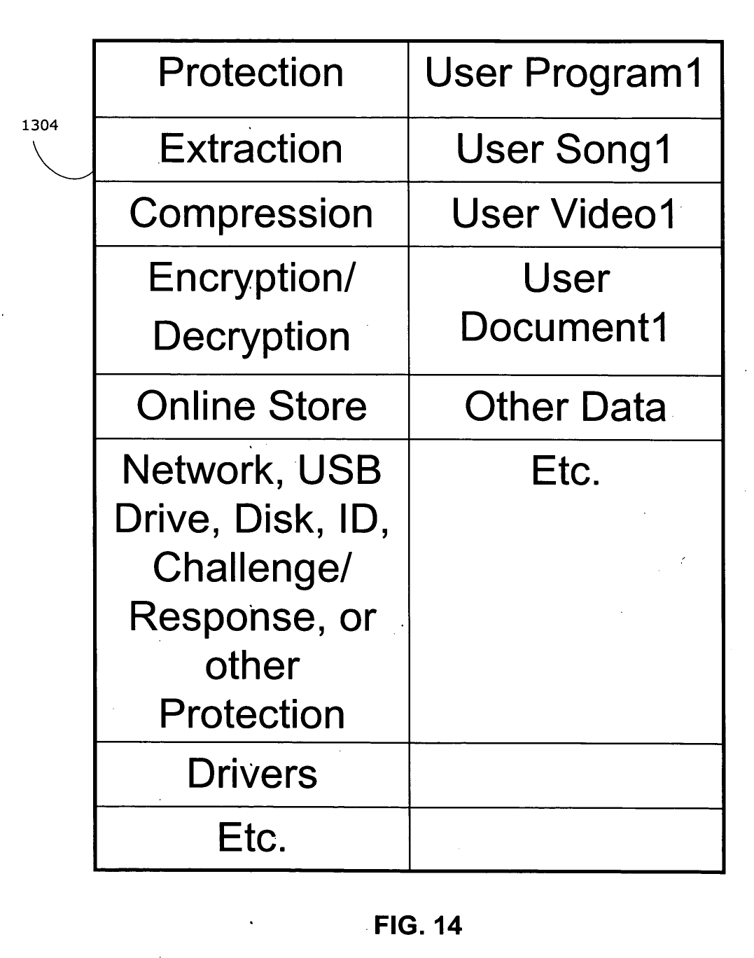

FIG. 14 depicts a table 2400 comprising the bytes stored as part of the system combining both data from the dongle, if any, and the data, if any, stored in a computer into which a dongle is plugged.

In some embodiments, all of the data can be stored on the computer; for example, this would be logical in working with a dongle which has nothing more than a unique ID and/or challenge/response system incorporating an ID.

In other embodiments of the system, an arbitrary amount of said bytes is stored on the dongle, for example in a flash card. For example, a USB flashcard could be used as a dongle using a unique serial number for identification. Any subset of bytes could be stored on the USB flashcard, including games, media (such as songs, documents, videos, and the like), the protection program, the program which allows the user to purchase software from an online store, the program which decrypts either a virtual CD from a game CD (to produce, for example, Game1), or an extraction program which converts the game CD to a series of bytes (to produce, for example, Game1). This selection happens with or without the herein disclosed tracking of which files are really used in the course of playing the game, any needed drivers, and other system programs.

In some embodiments these programs are arbitrarily combined into single programs.

In all cases, compression may be applied to the bytes, based either on the fact that the system has detected those bytes will not be used, or based on compression algorithms known to those skilled in the art.

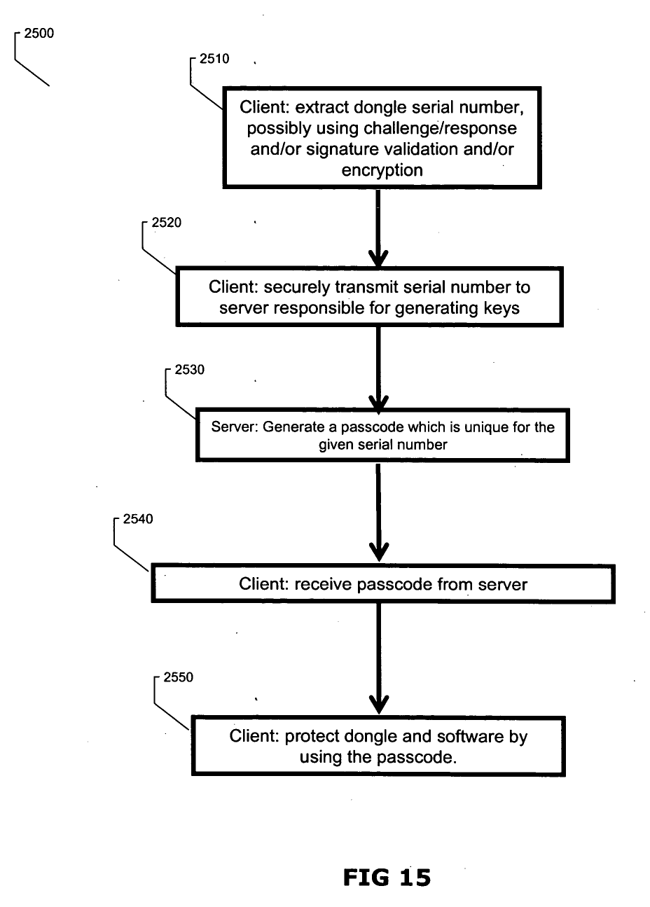

FIG. 15 is a sequence of operations 2500 for extracting a passcode given the serial number of a dongle for unique certificates, encryption, decryption, RSA encryption, or the like.

First at 2510, the client extracts the dongle serial number, in some embodiments drawing upon challenge/response technology, signature validation technologies, SSL technology, and/or other technologies which help prevent distortion of the dongle serial number.

Then at 2520 the client securely (for example, by using SSL) transmits a serial number to a remote server. In some embodiments the server is pre-arranged, in others the list is updated from a central site using SSL. The server is typically owned by a vendor or by the implementer of the disclosed system, or by others.

Then at 2530 the server generates a passcode which is unique for the given serial number. This forms the basis for protecting the dongle and software by using, for example, RSA public key technology for encryption, decryption, and challenge/response.

Then at 2540 the client securely receives the passcode from the server using an encryption mechanism such as SSL. Then at 2550 the client (also in this case a runner) uses the passcode for validation, encryption/decryption, using PKI/RSA challenge/response, or the like to ensure that all of the runner's portion of 1304 is user-accessible only when a dongle is inserted in the machine.

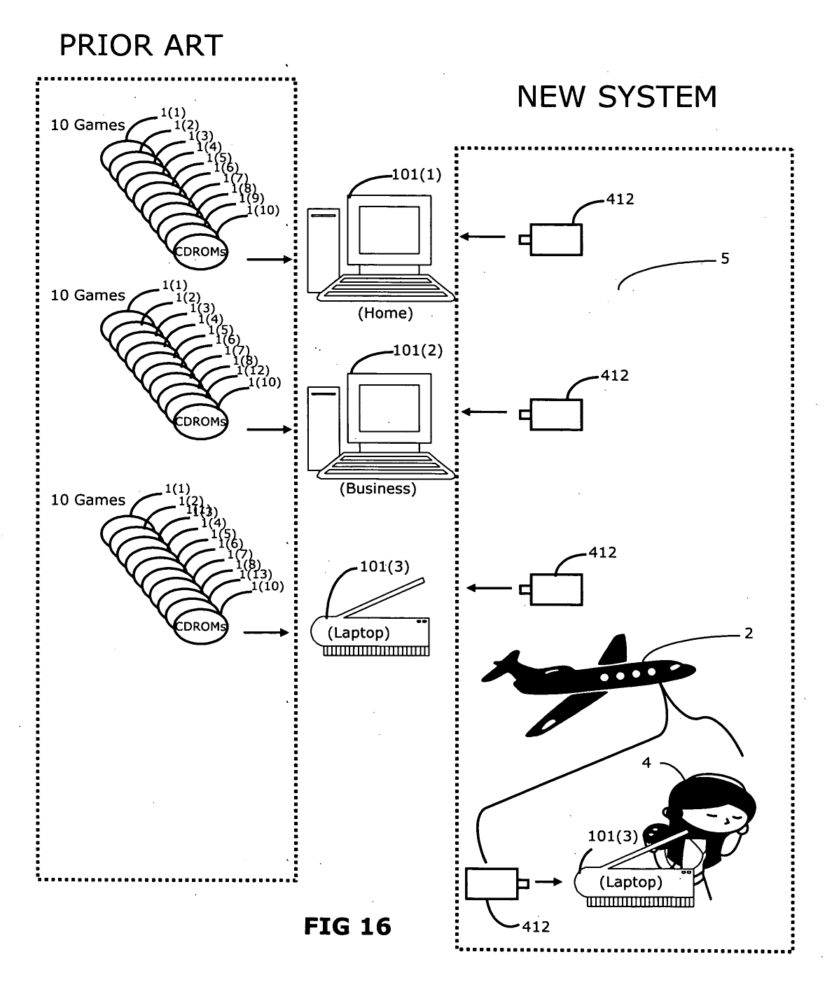

FIG. 16 is a depiction of one possible difference between prior art and the system herein disclosed. Using prior art, deploying 10 CD-protected games 1 on various computers (home 101(1), business 101(2), and a traveling laptop 101(3)) requires making sure that one has all of the copy protected disks. Also notice that one may have one set of games 1(1)-1(10) on one computer, 1(1)-1(8), 1(12), 1(10), on a second computer, and another set 1(1)-1(8), 1(13), 1(10) on a third computer requires making sure that one has the proper copy protected CD's at the right place at the right time to allow game play.

Using the system herein disclosed allows a single dongle 412 to be used on an airplane (by a person 4) enabling all of the games 1(1)-1(8), 1(13), 1(10) to be played without requiring access to the copy protected disks for those games.

### EXAMPLES OF USE

Those skilled in the art will find uses for the disclosed system which go beyond direct enumeration. Here are few examples of the application of this system.
This system allows game manufacturers to use the copy protection system while allowing users to use the program on as many computers as needed, one at a time.
This system facilitates security. The end user may not want certain programs to run on a machine that doesn't have a dongle.
A consortium of game developers could use the invention to provide a turnkey solution to mobile gaming. The game users get what they want: access to many games on a work computer (after hours, of course), access to the game using their laptop for commuting or flying, and access to the game on their home desktop. All of the games are, as herein disclosed, placed on all three runners. The system ensures that only one person uses the technology at a time.
Advanced virtual drives such as Virtual CD and CD Drive overcome copy protection using state of the art techniques such as identifying the type of protection and gathering the valid software (or one developed specifically for use with this system). By providing users with backup and multi-machine access technology, without having to have a separate dongle with each piece of software, enhances the value of the games to users.
The system can be applied to a sound, video, or program packages. By limiting use to one person at a time, copyrights are upheld. CD's and DVD's could be marketed on the Internet.
The system can be used to keep a fixed limit to the number of people using a limited resource. For example, if 10 police cars must available for emergency use, and there are 100 police cars, then 90 dongles or Internet-protected portions of this system can be used to ensure 10 are available.

While embodiments have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of accessing copy-protected software, comprising:
extracting software from a medium;
storing the software on more than one computer device;
using a single unique and detectable hardware to allow use of the extracted software.

2. A method as in claim 1, wherein multiple pieces of unique hardware unlock subsets of the sequestered software.

3. A method as in claim 2, wherein multiple networks may be used with multiple devices with arbitrary subsets of extracted software so as to ensure that, for each piece of extracted software, a policy is applied.

4. A method as in claim 1, wherein the medium is a CD or DVD.

5. A method as in claim 1, wherein the medium is a network.

6. A method of accessing copy-protected software, comprising:
downloading software to at least two computer device over a network;
using software in conjunction with network connections to all the computer devices to permit only a single computer device to run the software.

7. A method as in claim 7, wherein multiple networks may be used with multiple devices with arbitrary subsets of extracted software so as to ensure that, for each piece of extracted software, a policy is applied.

8. A method of accessing copy-protected software, comprising:
using a single dongle to validate the use of at least two software programs on a computer.

9. A method as in claim 8 further comprising, wherein use of the dongle includes the following steps:
obtaining a public key of the dongle;
generating a random block of data (R);
encrypting the data (R) using the public key to obtain data (E);
permitting the dongle to decrypt the data (E) using a private key of the dongle;
permitting the dongle to apply a hash function to the data (R) to obtain a hash value (H2);
permitting the dongle to encrypt (H2) using the public key;
applying a hash function to the data (R) to obtain (H1);
comparing (H1) and (H2) to determine if the dongle is valid.

10. The method of claim 9, wherein the hash function is an MD5 has function.

11. The method of claim 9, wherein the random block of data (R) is generated using an unstable oscillator.

12. A method of accessing copy-protected software, comprising
initiating an SSL communication with at least one validation server;
sending a unique ID of a runner followed by a list of ID numbers and hash values of two or more software titles to the validation server;
receiving from the server a list of invalid titles and a list of the hash codes of valid titles based on the server determining if the given ID of the runner has, ownership or is in trial;
comparing hashes of software titles with the hash codes returned by the server; and
providing an error indication if invalid software titles were discovered.
